(19) United States
(12) Patent Application Publication
(10) Pub. No.: US 2014/0317997 A1
(43) Pub. Date: Oct. 30, 2014

(54) Termite Electrocuting Apparatus

(71) Applicant: Neil Shumeng Wang, San Diego, CA (US)

(72) Inventor: Neil Shumeng Wang, San Diego, CA (US)

(21) Appl. No.: 13/870,976

(22) Filed: Apr. 25, 2013

(51) Int. Cl. E04B 1/72; A01M 1/22

(52) U.S. Cl. CPC E04B 1/72; A01M 1/223
USPC 43/132.1

(57) ABSTRACT

A termite electrocuting apparatus adapted to protect a structure with at least one vent opening and an access door from invading termites includes a step-up transformer, an AC/DC converter, at lease one wire mesh assembly connected to high DC voltage, and an on-off switch. The high voltage to the wire mesh assembly can be switched on and off in a highly reliable way to ensure safety when people are in proximity to the wire mesh assembly and to guarantee protection from invading termites. In particular, the switch device is integrated into the access door in such a way that the opening of the access door which happens when people need to get into the structure will automatically switch off the power to the high potential circuitry to remove the high potential hazard and the closing of the access door when people leaves the structure will automatically switch on the high potential circuitry to enable energized wire mesh assemblies to electrocute any termites that try to enter the structure.

### BACKGROUND

Several times a year drywood termites swarm to form new colonies. They grow wings and fly off from existing colonies in search of a new food source and a new home. In the western part of the United States, such as California, the wood destroying drywood termites can enter into a structure such as a house through vents in the attic. Once they land inside the attic, they lose their wings and crawl over surfaces of various wood framing members while seeking out the most desirable location to bore in and lay their eggs to start new colonies in the attics and eat away wood structure thereafter.

Home owners find out these uninvited termite guests in their houses usually after damage is done when they notice termite droppings, or worse damaged wood framing members. The cost of termite treatment and repair of damaged wood members can be significant. In many cases, especially when termites are spread across the wood structure of a house, tenting is the only viable option where an entire house is wrapped in a tent and the whole structure is fumigated with a termite killing agent. Tenting is not only expensive, it is also inconvenient. Home owners will have to stay in a hotel or with a friend for a few days, and food, utensils, silverware, and many other household items must be moved outside of the house during fumigation or cleaned after the fumigation. Obviously, treating termite problems after the fact is not the best choice.

Preventing termites from entering a structure is a much better choice. There are some known devices designed to electrocute termites and other insects. These devices typically include wire mesh assemblies that are charged or energized with high voltage potential. The conductive body of termites or other insects when they try to pass through the wire meshes will either create a short circuit allowing high current to pass through the insect's body or to facilitate a spark to jump between wire meshes resulting in electrocuting the termites or other insects. While such electrocuting devices can be effective in defending a structure from invading termites, they also pose as high voltage hazard to people. For instance, when these devices are used inside an attic of a typical house covering the vent openings, the high voltage energized wire meshes would be hazardous to people in proximity.

A manual on/off switch incorporated in the high potential circuitry and placed at or near the entrance of the attic access door can cut off, when needed, the power to the wire meshes thus eliminating safety hazard. However forgetting to turn the power off when a person enters the attic will expose the person to high potential hazard while forgetting to turn the power back on when the person exits the attic will expose the attic and the house to the risk of termite invasion and infestation.

To summarize, there is a need for a highly reliable way to use defend a structure from wood destroying termites while keeping the structure safe from high voltage hazard.

### SUMMARY

Described below is a termite electrocuting apparatus adapted to be installed in a structure with venting holes to prevent termites from entering the structure. More particularly, a termite electrocuting apparatus and the method described thereafter can protect a structure in a highly reliable yet safe way.

Other features and advantages will become apparent from the description and claims that follow.

### BRIEF DESCRIPTION OF THE DRAWINGS

The invention is described in greater detail hereinafter by reference to the accompanying drawings wherein:

FIG. 1 is a schematic diagram of the first embodiment of a termite electrocuting apparatus showing a high potential circuitry comprising a step-up transformer, an AC/DC converter, a wire mesh assembly, a switch 50, a plug 60 and a household wall socket 70.

FIG. 2 is a schematic diagram of the first embodiment of a termite electrocuting apparatus showing the breakdown of the components in the high potential circuitry.

FIG. 3 is a schematic diagram of the wire mesh assembly 30 in an isometric view.

FIG. 4 is a schematic diagram of the wire mesh assembly 30 in a side view.

FIG. 5 is a schematic diagram of the second embodiment of a termite electrocuting apparatus illustrating multiple wire mesh assemblies connected to the same high potential circuitry.

FIG. 6 is a schematic diagram of a house with an attic that includes vent openings and an access door.

FIG. 7 is a schematic diagram of a house with an attic that includes vent openings and an access door with the vent openings covered by wire mesh assemblies energized by a high potential circuitry including a transformer, an AC/DC converter and an on/off switch.

FIG. 8 is a schematic diagram of a pressure activated switch in an on-position and an off-position.

FIGS. 9a, 9b and 9c are schematic diagrams of an attic access door with a pressure switch incorporated. FIG. 9a shows the access door in a closed position with the pressure activated switch in an on position, FIG. 9b shows the access door in a partial open position, and FIG. 9c shows the access door in an open position with the pressure activated switch in an off position.

### DETAILED DESCRIPTION

This invention provides a system that can reliably switch on a high potential circuitry to energize one or more wire mesh assemblies adapted to cover vent openings of a structure to electrocute and kill termites that try to enter the structure and switch off the high potential circuitry to de-energize wire mesh assemblies to eliminate high potential hazard when people need to be in close proximity to the wire mesh assemblies. In particular, a switch device is integrated into an access door that leads to the structure within which the wire mesh assemblies are located and positioned. The opening of the access door which happens when people need to get into the structure will automatically switch off the power to the high potential circuitry, whereas the closing of the access door when people leaves the structure will automatically switch on the high potential circuitry.

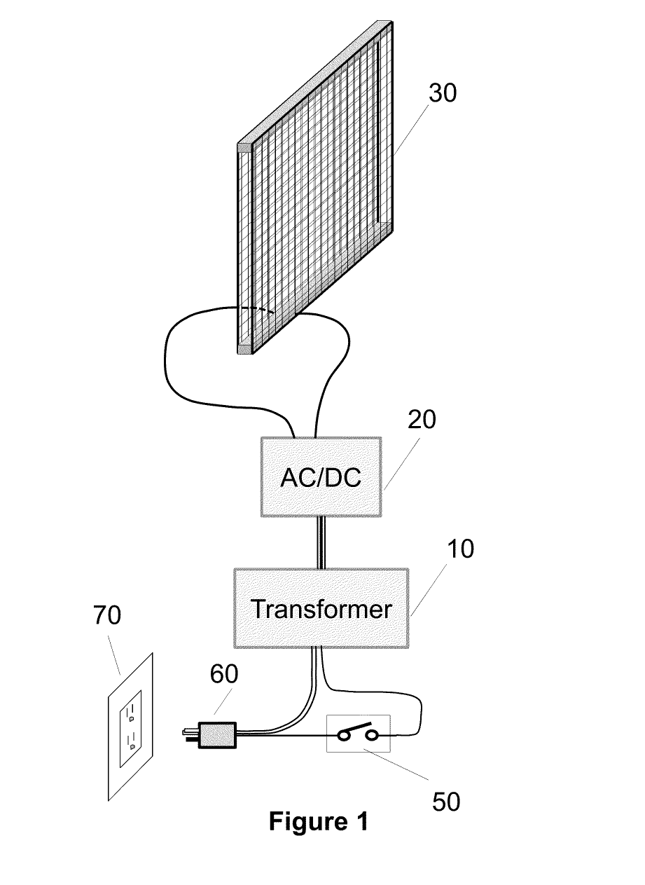

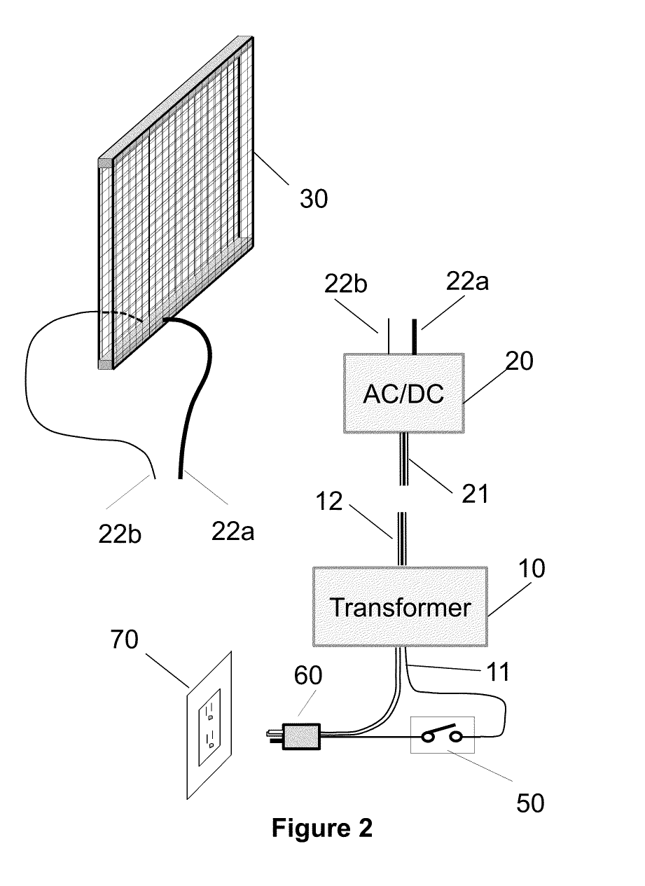

Referring to FIGS. 1 and 2, the termite electrocuting apparatus there illustrated comprises a step-up transformer 10, an AC/DC converter 20, a wire mesh assembly 30 and an on/off switch 50. The input side 11 of transformer 10 has a plug 60 that plugs into a wall socket 70 where ordinary household AC voltage is available. The output side 12 of transformer 10 provides a voltage that is significantly higher than that is available at the input side 11. The input side 21 of AC/DC converter 20 is connected to the output side 12 of transformer 10, and the output side of AC/DC converter 20 provides a DC output with a high-voltage potential lead 22a and a ground lead 22b. The high-voltage potential lead 22a and the ground lead 22b are connected to the wire mesh assembly 30 to complete the high potential circuitry which is controlled by the switch 50 that can turn power on to energize or turn power off to de-energize the wire mesh assembly 30.

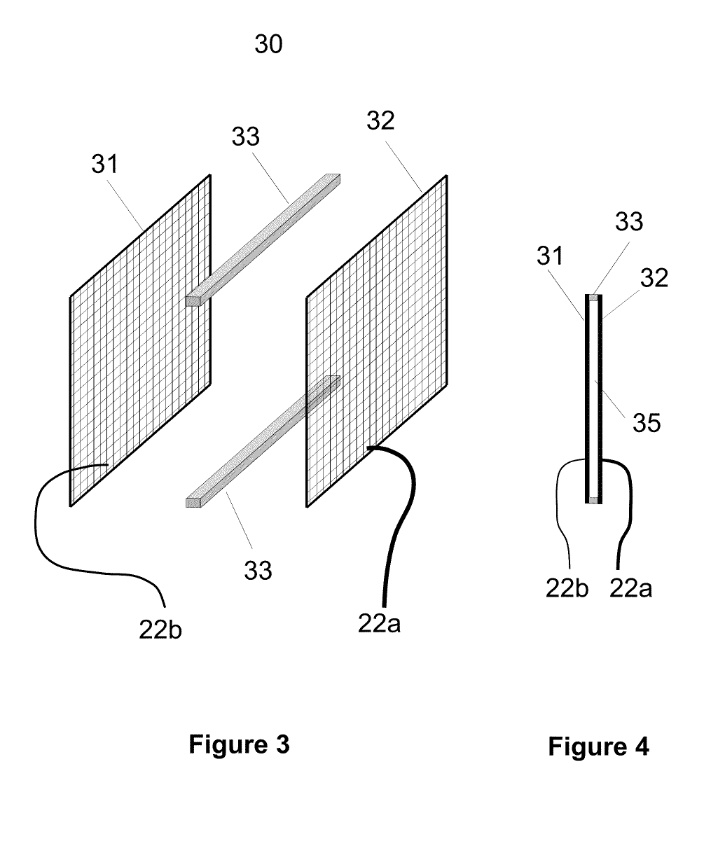

Referring to FIGS. 3 and 4, the wire mesh assembly 30 comprises a first electrically conductive wire mesh 31, a second electrically conductive wire mesh 32, and multiple spacers 33 made of electrically insulating material such as plastic. The first wire mesh 31 is disposed generally in parallel to the second wire mesh 32 and the spacers 33 separate the first wire mesh 31 and the second wire mesh 32 to form a space or a gap 35 between two wire meshes 31 and 32, and to keep the first wire mesh 31 electrically insulated from the second wire mesh 32. Desirably the high potential lead 22a is connected to the first wire mesh 31 and the ground lead 22b is connected to the second wire mesh 32. The opening of the wire meshes 31 and 32 is sufficiently large to provide adequate ventilation which will possibly allow insects including termites to gain access to space 35 formed between wire meshes 31 and 32. The intrusion of the insects or termites causes short circuiting across the conductive body of the insects or at least a spark jump across both wire meshes 31 and 32 resulting in the electrocution and kill of the insects and termites trying to pass through the wire mesh assembly 30.

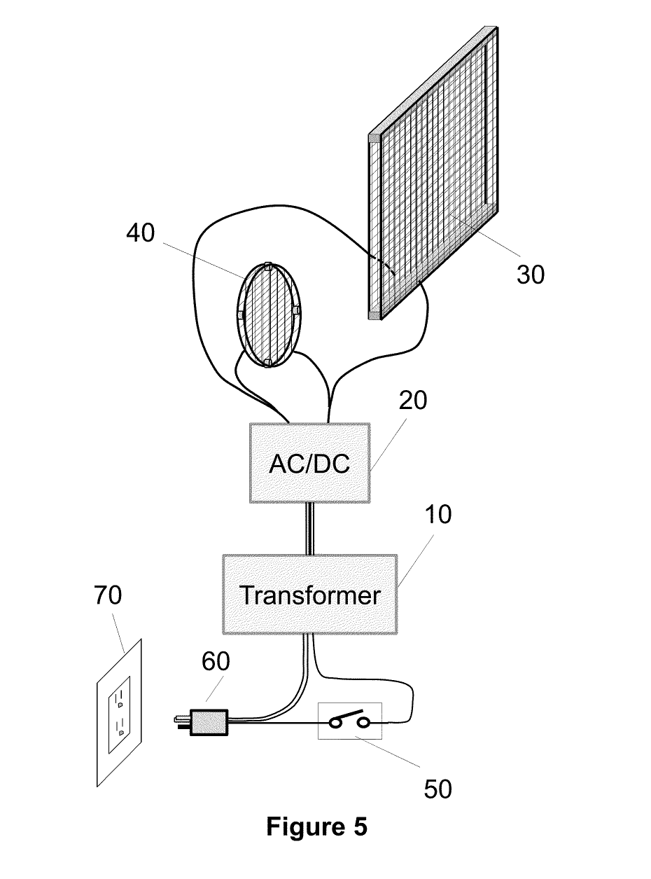

There can be more than one wire assembly attached to the output end of AC/DC 20 and the wire mesh assemblies can be different shapes and sizes. FIG. 5, shows one wire assembly 30 which is significantly rectangular in shape and one wire assembly 40 which is significantly circular. Both wire assemblies 30 and 40 are shown to be connected the output end of AC/DC 20.

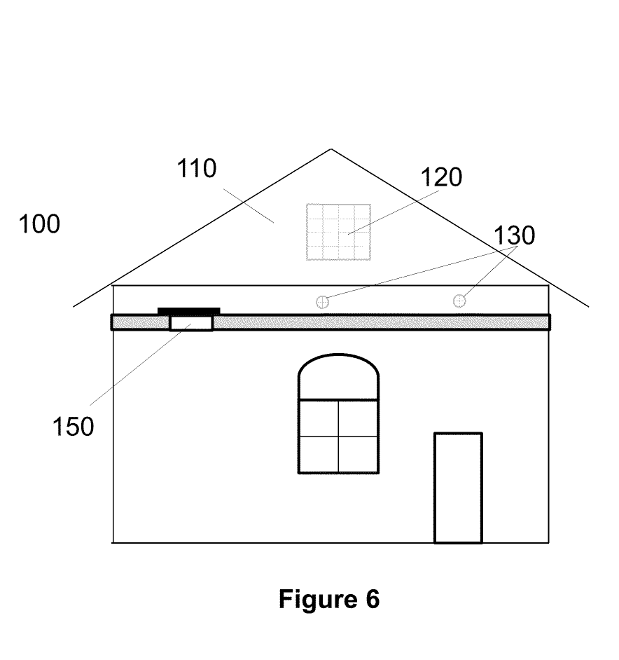

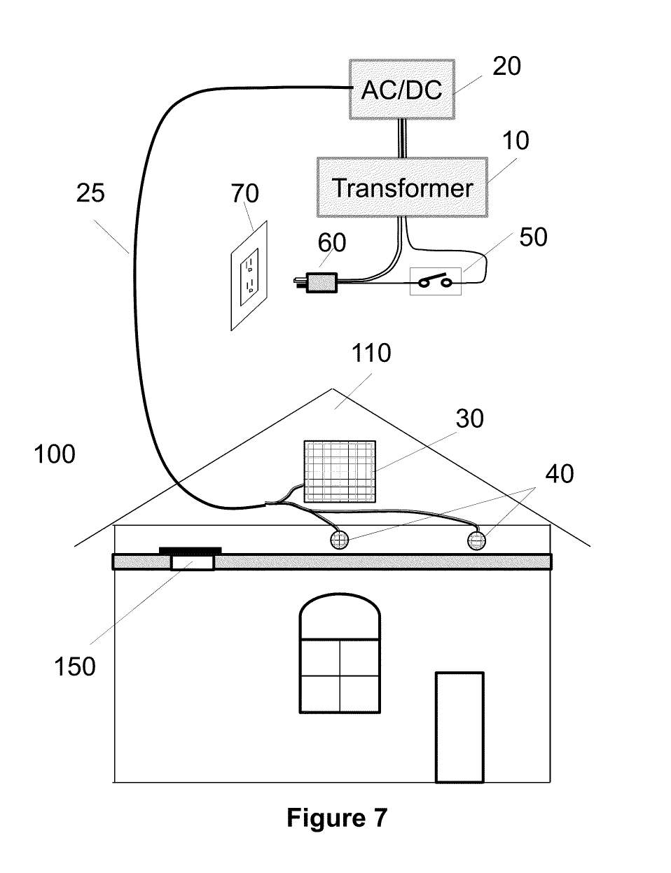

Illustrated in FIGS. 6 and 7 is an attic space 110 inside a house 100. Inside the attic 110 there are multiple vent openings 120 and 130 of different shapes and sizes. There is also an access door 150 on the ceiling to enable access by people to get in and out of the attic 110 from underneath. Obviously, the attic 110 can be a structure other than an attic and the access door can be of different size, shape and orientation. To prevent termites from entering the attic 110, the vent openings 120 and 130 are covered by wire mesh assemblies 30 and 40 that are part of a high potential circuitry including a transformer 10 that is plugged into a household wall socket 70 and an AC/DC converter 20.

Since people will need to get into the attic 110 for various reasons, an on/off switch 50 as shown in FIG. 7 needs to be incorporated in the high potential circuitry to eliminate safety hazard posed by high potential charged wire mesh assemblies 30 and 40. While a manual switch such as a household wall toggle switch can be used for the purpose, forgetting to turn the power off when the person enters the attic 110 will expose the person to high potential hazard and forgetting to turn the power back on when the person exits the attic 110 will expose the attic 110 and the house 100 to the risk of termite invasion and infestation.

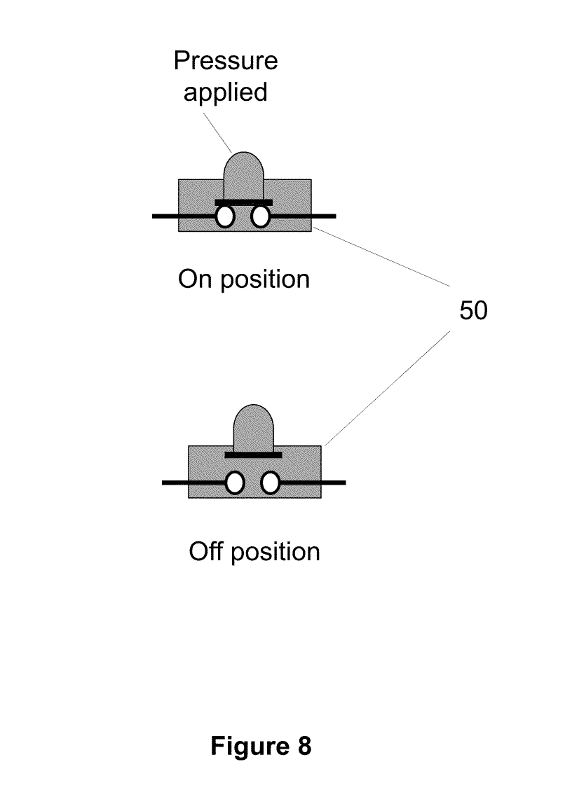

A switch device 50 integrated into the access door 150 described below enables this termite electrocuting apparatus to work safely and effectively in a highly reliable way. The switch 50 as illustrated in FIG. 8 is preferably a pressure activated switch. In a depressed position with pressure applied to the switch 50, the switch 50 is in a closed or electrically on state. When pressure is removed from the switch 50, the switch 50 is in an open or off state.

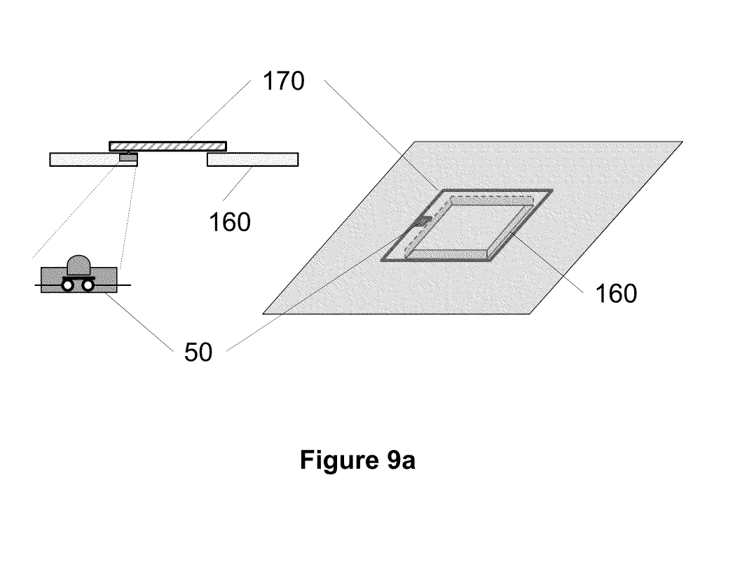

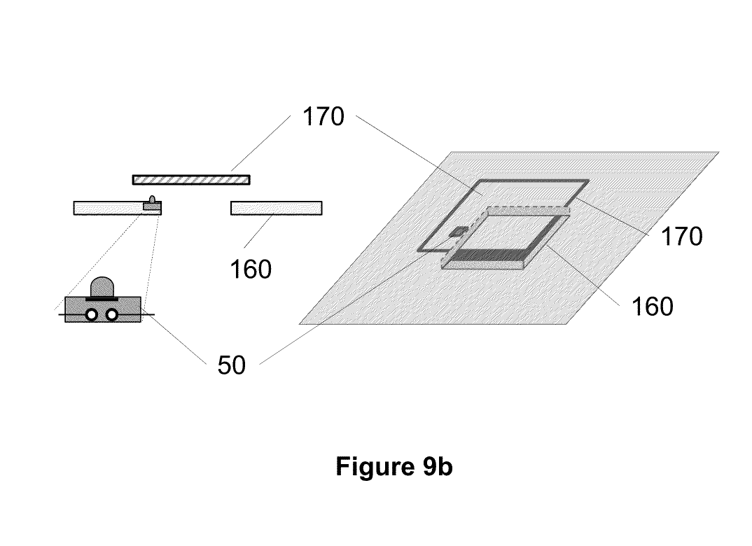

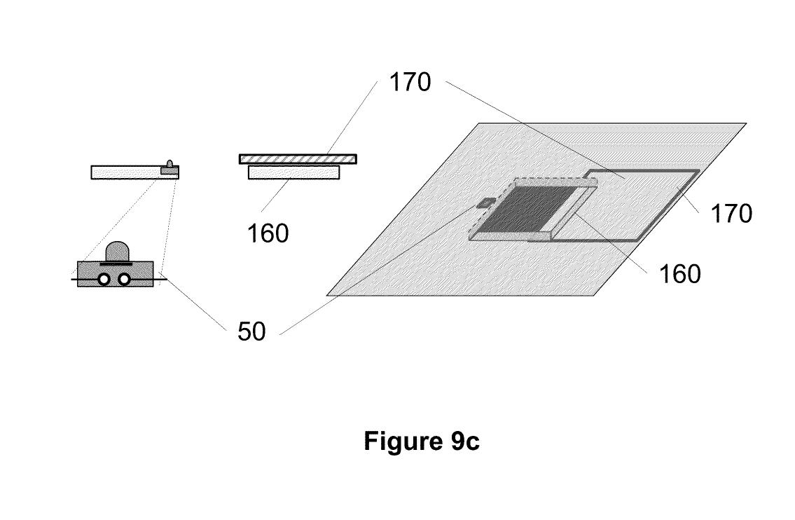

FIGS. 9a, 9b, and 9c illustrate the integration of the pressure activated switch 50 into the access door 150 to achieve the goal of reliably controlling the operation of the high potential circuitry as shown in FIG. 7. The access door 150 located on the ceiling in a typical house has a door frame 160 and a door panel 170. The pressure activated switch 50 is located along a side of the door frame 160 in such a way that, when the access door 150 is closed with the door panel 170 resting on and covering the frame 160 as shown in FIG. 9a, the switch 50 is pressed down by the door panel 170 causing the switch 50 to be in a closed or on state and the high potential circuitry and the wire mesh assemblies 30 and 40 to be powered on and energized. When a person reaches the door panel 170 from underneath to open the access door 150, the displacement of the door panel 170 from covering the door frame 160 frees up the switch 50 from being pressed as illustrated in FIGS. 9b and 9c causing the switch 50 to be in an open or off state and the high potential circuitry and the wire mesh assemblies 30 and 40 to be powered off and de-energized.

While the invention and exemplary embodiments of the invention have been illustrated and described in general and specific terms, it should be understood that the invention may be modified and otherwise embodied in still other forms, including but not limited to all forms which are obvious variants of or equivalent to those disclosed.

The preceding descriptions are by way of example and are not intended to limit or restrict the scope of the invention which is specified and defined by the appended claims.

I claim:

1. A termite electrocuting apparatus for use in a structure with at least one vent opening for allowing ventilation between inside and outside said structure and an access door having a door frame and a door panel for allowing access to said structure by people, comprising:
A step-up transformer having an input side plugged into a wall AC power outlet and an output side
At least one wire mesh assembly adapted to cover said vent opening, the wire mesh assembly having a first wire mesh made of electrically conductive material, a second wire mesh made of electrically conductive material, and at least one spacer that is made of electrically insulating material and that is sandwiched between said first wire mesh and said second wire mesh to keep said first wire mesh from directly contacting said second wire mesh and to keep said first wire mesh and said second wire mesh in a significantly parallel relationship
An AC-DC converter for converting AC voltage from said output side of said transformer into DC voltage to provide a high DC voltage potential to said first wire mesh and a ground DC voltage potential to said second wire mesh such that said wire mesh assembly will electrocute termites as they try to enter said structure through said vent opening
Means for switching power on and off to said wire mesh assembly

2. The insect electrocuting apparatus of claim 1, wherein said means for switching power on and off to said wire mesh assembly is a pressure activated switch with said switch being in an on state when pressure is applied to said switch and being in an off state when pressure is removed, said pressure activated switch is disposed along said access door frame in such a way that said pressure switch is being pressed upon when said access door panel is in a significantly shut position causing said switch to be in an on state to energize said wire mesh assembly and that said pressure switch is in a free state when said access door panel is in a significantly open position causing said switch to be in an off state to de-energize said wire mesh assembly to remove high voltage hazard.

3. A termite electrocuting apparatus for use in a structure with at least one vent opening for ventilation between inside and outside said structure and an access door, comprising:
At least one wire mesh assembly for use to cover said vent opening comprising a first electrically conductive wire mesh, a second electrically conductive wire mesh, at least one electrically insulating spacer disposed between said first wire mesh and said second wire mesh to keep said first wire mesh and said second wire mesh electrically disconnected
Means for providing high-voltage potential to said wire assembly
Means for switching the operation of said means to provide high-voltage potential and wire mesh assembly; wherein said means for switching the operation being disposed in said access door in such a way that powering off the operation is achieved by opening said access door and powering on the operation is achieved by closing said access door.
